(19) United States
(12) Patent Application Publication
(10) Pub. No.: US 2008/0077920 A1
(43) Pub. Date: Mar. 27, 2008

(54) System for suggesting training

(76) Inventors: Andreas Faatz, Darmstadt (DE); Manuel Goertz, Darmstadt (DE)

Correspondence Address: FISH & RICHARDSON, P.C., PO BOX 1022, MINNEAPOLIS, MN, 55440-1022, US

(21) Appl. No.: 11/524,596

(22) Filed: Sep. 21, 2006

(51) Int. Cl. G06F 9/46

(52) U.S. Cl. 718/100

(57) ABSTRACT

A system for suggesting training includes generating a process flow model made-up of tasks, identifying a target task in the process flow model that fails or is not performed according to one or more predefined criteria, identifying critical tasks which are necessary to perform the target task, and suggesting training for critical tasks.

### TECHNICAL FIELD

This patent application relates, in general, to a system for suggesting training and, more particularly, to a system for suggesting training in a process flow (e.g., workflow) context.

### BACKGROUND

Process flows, such as workflows, include interdependent tasks. Each task may have one or more competencies associated therewith. For example, a process flow for building a computer may include tasks such as obtaining hardware, connecting the hardware, loading software, and testing the software to make sure that the computer is working. The task of connecting the hardware may require competencies, such as knowledge of the hardware's capabilities and compatibilities, the ability to solder electronics, and familiarity with power supplies and grounding.

If a worker is unable to perform one of the foregoing tasks due, e.g., to a lack of a competency required to perform the task, the process flow will be hindered. In the above example, if the worker is unable to solder electronics, the process flow for building the computer will be interrupted and not completed.

### SUMMARY

This patent application describes methods and apparatus, including computer program products, for suggesting training in a process flow (e.g., workflow) context.

In general, in one aspect, this application describes a system for generating a process flow model comprised of tasks, identifying a target task in the process flow model that fails or is not performed according to one or more predefined criteria, identifying critical tasks which are necessary to perform the target task, and suggesting training for critical tasks. This aspect may also include one or more of the following features.

Competencies may be associated with the tasks in the process flow model. The target task may have one or more associated competencies. Identifying critical tasks which are necessary to perform the target task may comprise comparing the one or more associated competencies with competencies of a worker who is to perform the target task, identifying, based on the comparison, an associated competency that is not possessed by the worker, and obtaining the critical tasks using the associated competency.

Obtaining the critical tasks using the associated competency may comprise traversing a conceptual lattice that relates at least some of the tasks to at last some of the associated competencies. Identifying the critical tasks which are necessary to perform the target task may comprise identifying one or more tasks that previously failed.

The critical tasks may be ordered based on priority. The training for critical tasks may be suggested based on the priority. The priority may correspond to one or more costs associated with the critical tasks. The critical tasks may be ordered based on time. The training for critical tasks may be suggested based on a temporal order of the critical tasks. The critical tasks may be ordered based on both priority and time. The training for critical tasks may be suggested based on the priority and on a temporal order of the critical tasks.

It may be determined whether the process flow model is sound. If the process flow model is sound, training for a critical task may be suggested that is earliest or has a highest priority. If the process flow model is sound, training may be suggested for competencies associated with the critical task staring with a general competency. If the process flow model is not sound, the system may further comprise identifying a subset of the process flow model that is sound, and suggesting training for a critical task in the subset of the process flow model that is earliest or has a highest priority.

The foregoing system may be implemented as a method, an apparatus, and/or an article of manufacture, such as one or more machine-readable media comprising instructions that are executable by one or more processing devices to implement the actions described above, either automatically or interactively.

The details of one or more examples are set forth in the accompanying drawings and the description below. Further features, aspects, and advantages of the invention will become apparent from the description, the drawings, and the claims.

### DESCRIPTION OF THE DRAWINGS

FIG. 1 is a flow chart showing an example of a process for suggesting training for critical tasks.

FIG. 2 shows an example graphical representation of a task-competency lattice.

FIG. 3 shows an example graphical representation of a process flow model.

FIG. 4A shows an example graphical representation of a process flow model that fails a termination soundness condition.

FIG. 4B shows an example graphical representation of a process flow model that fails a real-time soundness condition.

Like reference numerals in different figures indicate like elements.

### DETAILED DESCRIPTION

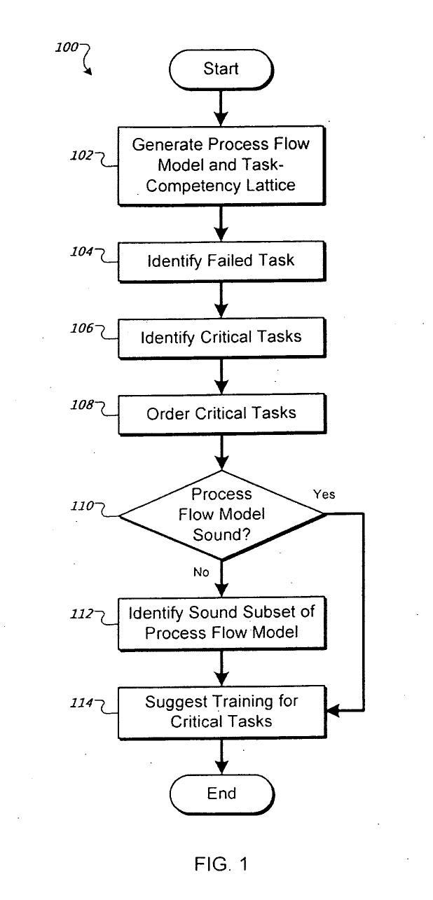

FIG. 1 is a flow chart showing an example of a process 100 for suggesting training for critical tasks. In certain implementations, a user performs the training during an informal learning session (e.g., a learning session performed without pre-defined support by curricula or textbooks). Typically, the learning environment is closely embedded in the working place and the learning environment is related to the order of tasks a worker wishes to, or must, fulfill while working. Such tasks may be knowledge-intensive and the effect of some or all of the training measures may be monitored by the outcome of the tasks. Process 100 provides for the detection of positive or negative consequences of particular training measures. Additionally, process 100 shows how to plan individual training measures for a worker corresponding to the tasks for which the worker is responsible.

Process 100 begins with generating (102) a process flow model and a task-competency lattice. Tasks are ordered in a process flow model. The process flow model is later analyzed to retrieve the temporal order of tasks. Tasks, competencies, and concepts are structured in a task-competency lattice. The task-competency lattice is later analyzed to retrieve the conditional interdependency of tasks. The order and interdependency of tasks are used to provide information regarding positive or negative consequences for the task structure. The positive or negative consequences are used to suggest training measures.

Task-competency modeling is based on formal concept analysis, which is an indirect and qualitative way of determining the abilities of learners. The fulfillment of a task is the indicator of a set of necessary competencies. The core is a matrix structure, referred to as a formal context, which has tasks as its rows and competencies as its columns. The following table is an example of a formal context having tasks A through F, and competencies of language, abstraction, and Unified Modeling Language (UML):

| | Competency | | |
|---|---|---|---|
| Task | Language | Abstraction | UML |
| Task A | X | X | X |
| Task B | | X | X |
| Task C | X | | X |
| Task D | X | X | X |
| Task E | X | | X |
| Task F | X | X | |

An X in a particular row and column of the table above indicates that the task in that row requires the competency in that column. A task performed by a person in a workflow (e.g., a workflow for preparation of a document) is an indicator of the person's competencies. Some examples of competencies include language, ability to abstract, ability to structure a topic, and domain knowledge. By evaluating the quality of a task output (e.g., the quality of a document created by the learner), the competencies which enable a person to fulfill the task are determined. The formal context in the table above is the basis for defining formal concepts, which can be ordered in a lattice for navigation. The following table is an example of formal concepts for the six tasks and three competencies in the formal context above:

| Formal Concept | Tasks | Competencies |
|---|---|---|
| Formal Concept A | <{A, B, C, D, E, F}, | { }> |
| Formal Concept B | <{A, C, D, E, F}, | {language}> |
| Formal Concept C | <{A, B, D, F}, | {abstraction}> |
| Formal Concept D | <{A, B, C, D, E}, | {UML}> |
| Formal Concept E | <{A, D, F}, | {language, abstraction}> |
| Formal Concept F | <{A, C, D, E}, | {language, UML}> |
| Formal Concept G | <{A, B, D}, | {abstraction, UML}> |
| Formal Concept H | <{A, D}, | {language, abstraction, |
| | | UML}> |

The table above represents each formal concept as a pair of sets. The first set in each pair is a set of the tasks that are dependent on the formal concept. The second set in each pair is a set of competencies required for the formal concept. Each concept includes competencies that are common to the tasks required for that concept. The structure of the formal concept allows planning the training measures of an organization. Alternatively, the lattice of formal concepts may be represented graphically.

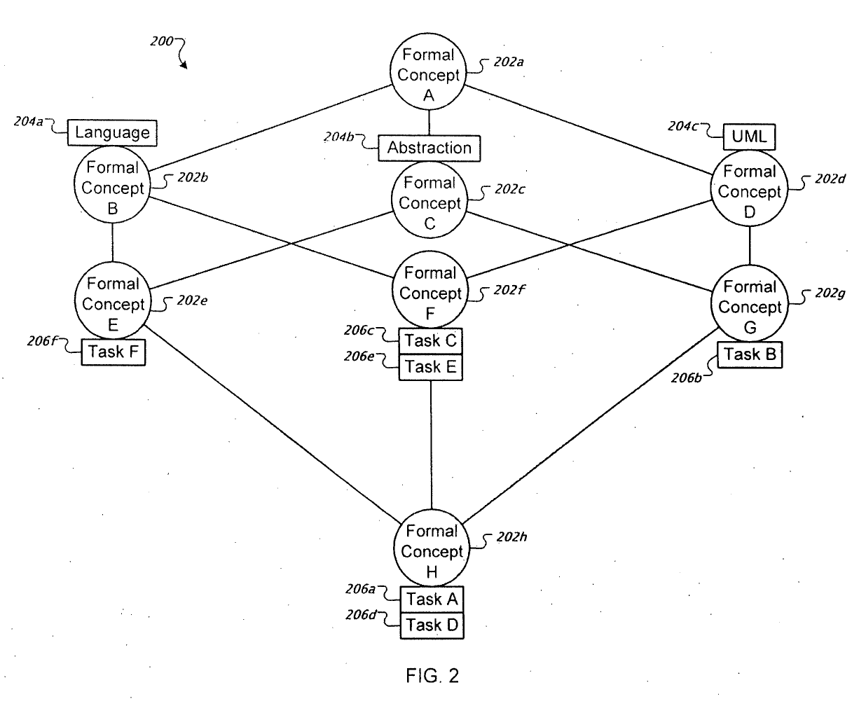

FIG. 2 shows an example graphical representation of a task-competency lattice 200. Task-competency lattice 200 includes formal concepts 202a-h, competencies 204a-c, and tasks 206a-f. Edges in task-competency lattice 200 indicate hierarchical relationships between the formal concepts. For example, formal concepts 202b-h are sub-concepts of formal concept 202a.

Dependent tasks of a particular formal concept include tasks of the particular formal concept itself as well as tasks of other formal concepts below the particular formal concept in task-competency lattice 200. For example, formal concept 202f includes its tasks 206c and 206e as well as tasks 206a and 206d of formal concept 202h which lies below formal concept 202f in task-competency lattice 200.

Required competencies of a particular formal concept include competencies of the particular formal concept itself as well as competencies of other formal concepts above the particular formal concept in task-competency lattice 200. For example, formal concept 202g includes competency 204b from formal concept 202c and competency 204c from formal concept 202d which both lie above formal concept 202g in task-competency lattice 200.

Task-competency lattice 200 allows a user to visually determine dependent tasks of a formal concept as well as required competencies of a formal concept. Task-competency lattice 200 enables self-directed learning by allowing a user to determine which formal concept training measures match the user's training needs.

Task-competency lattice 200 presents a hierarchical relationship between formal concepts 202a-h as well as task dependencies and competency requirements. In the example shown here, task-competency lattice 200 does not indicate temporal ordering of tasks performed by a person. Temporal ordering of tasks may be represented using a process flow model.

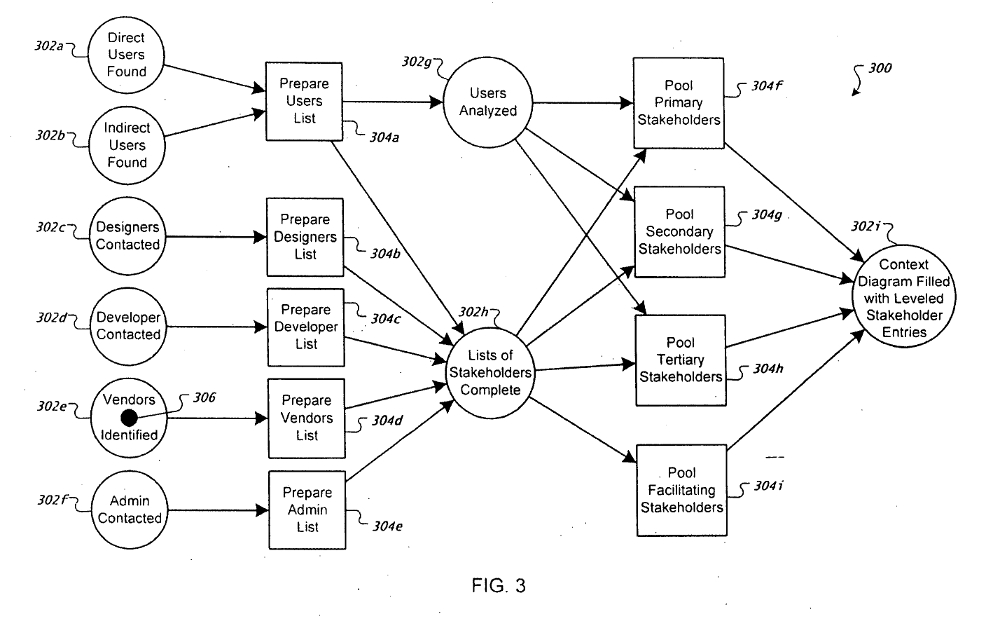

FIG. 3 shows an example graphical representation of a process flow model 300. Process flow model 300 is represented here as a Petri net. Alternatively, process flow model 300 may be represented using another process flow modeling technique based on Petri nets, such as YAWL (Yet Another Workflow Language). Alternatively, the process flow model may be expressed in event-based languages such as BPEL (Business Process Execution Language), XPDL (XML Processing Description Language, where XML stands for eXtensible Markup Language) or UML (Unified Modeling Language) activity diagrams. These alternate expressions may, or may not, require a mapping to a Petri net. Process flow model 300 includes places 302a-i and transitions 304a-i.

Places 302a-i represent states that may be reached in the workflow. When a state is reached in the workflow, a token is placed in its place. For example, place 302e includes token 306 indicating that vendors have been identified.

Transitions 304a-i represent tasks that a person may perform. A transition may be performed after places having edges leading to the transition include tokens. In other words, places having edges leading to a transition are states that must be reached before the transition may be performed. For example, transition 304d may be performed because place 302e includes token 306, that is, a vendor list may be prepared because the vendors have been identified.

After transitions leading to a place have been performed successfully, the place is given a token. For example, after successfully completing transitions 304a-e, place 302h is given a token. In certain implementations, a place may include multiple tokens, such as a token for each user participating in the workflow. A user's tokens may be represented by a color that identifies the tokens as belonging to the user. In certain implementations, each of the transitions 304a-i may include time information indicating the amount of time that may elapse before the transition produces an outgoing token. If a transition is not completed successfully, no token is generated. In addition, if a transition is completed in a non-sufficient manner, a token may be generated, but future transitions may fail as a result of the non-sufficient completion. Training measures may be taken to correct failures and non-sufficient completions.

Referring again to FIG. 1, process 100 identifies (104) a failed task or a task that is not performed according to one or more predefined criteria. For example, a failure may originate from outside an organization (e.g., a customer refuses to accept a work product), internal to an organization (e.g., an internal review of worker performance), or through self-assessment. In the case of a failed transition, the state of tokens in process flow model 300 is retrieved prior to the performance of the transition. In the case of a non-sufficiently completed transition, the state of tokens in process flow model 300 is retrieved after the performance of the transition.

Process 100 identifies (106) critical tasks which are necessary to perform the failed task. Process 100 may use two methods to identify critical tasks: a competency-based method and a task-based method.

The competency-based method retrieves competencies associated with the failed task. Associated competencies may be identified using the task-competency lattice 200. Competencies of the person performing the failed task are also retrieved. The competencies of the person may be stored, for example, electronically or a user may input the person's competencies. The competencies associated with the failed task and the competencies of the person are compared to determine one or more insufficient competencies associated with the failed task that are not competencies of the person. Formal concepts in task-competency lattice 200 are identified that have one or more of the insufficient competencies. Task-competency lattice 200 is traversed to identify tasks included in or prior to each of the identified formal concepts having insufficient competencies. The identified tasks are critical tasks and may result in training measures being taken for the person performing the failed task.

For example, a person may fail task 206a, which is included in formal concept 202h. Formal concept 202h requires competencies 204a-c. The person may possess competencies 204b-c. Therefore, competency 204a is determined to be insufficient. Formal concepts 202b, 202e, 202f, and 202h require competency 204a. Formal concepts 202b, 202e, 202f, and 202h include dependent tasks 206a and 206c-f. Therefore, tasks 206a and 206c-f are identified as critical tasks.

The task-based method of identifying critical tasks identifies tasks in the future that are at risk of failing due to lacking competencies. Temporal order of tasks may be determined using a process flow model, such as process flow model 300. The temporal ordering can be determined, e.g., in advance by generating the task-competency lattice using successfully fulfilled tasks and future tasks only, or a posteriori by filtering critical tasks according to their occurrence in time (past/future). Tasks occurring in the future from the highest formal concept containing the failed task are identified as critical tasks in the task-based method. For example, if task 206a fails, then formal concept 202h is the lowest concept in task-competency lattice 200 that contains task 206a. Therefore, tasks 206a and 206d are identified as critical tasks.

In addition, if another task failed in the past, then tasks occurring in the future from the past task may be intersected with the tasks occurring in the future from the current failed task to determine a set of critical tasks. For example, task 206b may have previously failed, while task 206d is currently failed. The lowest formal concept that includes task 206b is formal concept 202g and the highest formal concept that includes task 206d is formal concept 202h. The sets of tasks that occur in the future from formal concepts 202g and 202h are {task 206a, task 206b, task 206d} and {task 206a, task 206d}, respectively. The intersection of the two sets in this example is {task 206a, task 206d}. The tasks 206a and 206d in the intersection are identified as critical tasks. Furthermore, if one or more failed tasks exist in the past, this method may be repeated to determine critical tasks.

Process 100 orders (108) the identified critical tasks based on priority and/or time. In the case of the competency-based method of identifying critical tasks, costs are assigned to each insufficient competency. The cost of an insufficient competency increases with the level of insufficiency of the competency. For each critical task, the costs of required competencies are summed to determine a priority. Critical tasks may be ordered by the priorities. A higher priority indicates a higher likelihood that the critical task will not be performed and is placed earlier in the ordering of the critical tasks than a critical task having a lower priority.

Alternatively, in either the competency-based method or the task-based method, critical tasks may be ordered based on the temporal order of the critical tasks. For example, transitions 304a-e (and their corresponding tasks) occur before transitions 304f-i (and their corresponding tasks). In addition, process flow model 300 may include time information further specifying the order in which transitions occur so that the transitions 304a-i may be ordered, for example, along a timeline. A critical task occurring earlier in process flow model 300 receives an earlier placement in the ordering of the critical tasks than a critical task that occurs later in process flow model 300.

If the process flow model is not sound (110), then process 100 identifies (112) a subset of the process flow model that is sound. A process flow model is sound if the process flow model terminates eventually. For example, if a place in a process flow model is not able to receive a token or, due to some real-time condition will never contain a token, then any transitions dependent on that place will not be performed, the process flow model does not terminate, and the process flow model is not sound.

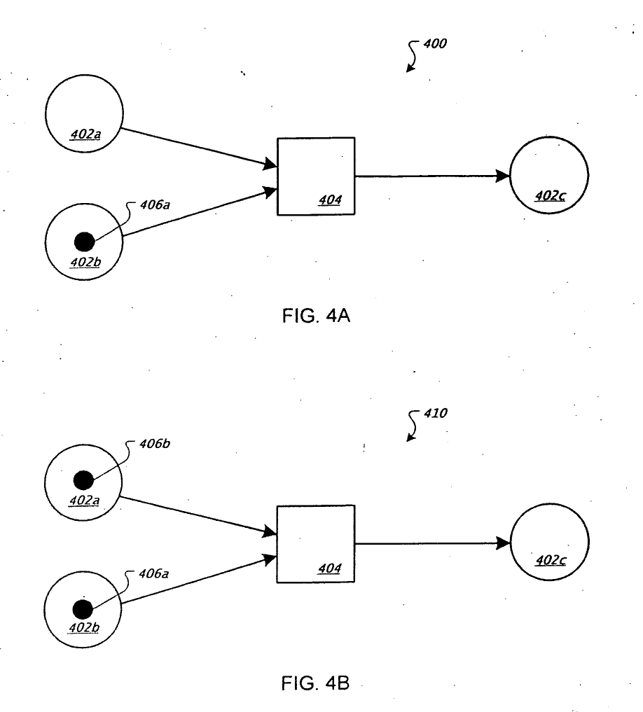

FIG. 4A shows an example graphical representation of a process flow model 400 that fails a termination soundness condition. Process flow model 400 includes places 402a-c, a transition 404, and a token 406a. Transition 404 is dependent on places 402a-b. Transition 404 cannot be performed due to the persistent lack of a token at place 402a. Therefore, process flow model 400 will not reach place 402c and process flow model 400 will not terminate. Process flow model 400 fails the termination soundness condition.

FIG. 4B shows an example graphical representation of a process flow model 410 that fails a real-time soundness condition. Again, transition 404 is dependent on places 402a-b. In this example, places 402a-b include tokens 406b and 406a, respectively, and transition 404 may be performed, thereby terminating process flow model 410. However, if transition 404 includes a condition that the transition must be performed in, for example, one hour and the transition takes one day to perform, then process flow model 410 violates the real-time condition and is not sound.

In either case, transitions that cause one of the soundness criteria to fail are disabled. For example, an empty incoming place may be added before the transition. The empty place with no transition coming into it will never be triggered and effectively disables the transition after it. A subset of the process flow model resulting from the disabled transitions may then be identified and the soundness criteria may be applied again.

Referring again to FIG. 1, process 100 suggests (114) training for critical tasks. If the process flow model was sound, then the suggestion may be based on the ordering of the critical tasks as determined by the priority and/or temporal ordering methods. If the process flow model was not sound, then competencies causing a failure or that endanger failure in an earliest critical task are suggested for training. Alternatively, required competencies of a special formal concept, which is above the formal concepts associated with the critical tasks, may be suggested for training. The process may be repeated until one or more required competencies are determined or no more critical tasks exist.

Process 100 and any modifications thereto described herein or elsewhere (referred to collectively as “the processes”) are not limited to use with the hardware and software described above; they may find applicability in any computing or processing environment and with any type of machine that is capable of running machine-readable instructions. The processes can be implemented in digital electronic circuitry, computer hardware, firmware, software, or combinations thereof.

The processes can be implemented via a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Actions associated with the processes can be performed by one or more programmable processors executing one or more computer programs to perform the functions of the processes. The actions can also be performed by, and the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks.

The processes can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the processes, or any combination of such back-end, middleware, or front-end components. The components of the system can be interconnected by any form or medium of digital data communication, e.g., a communication network. Examples of communication networks include a LAN and a WAN, e.g., the Internet.

Activities associated with the processes can be rearranged and/or one or more such activities can be omitted to achieve the same results described herein. All or part of the processes may be fully automated, meaning that they operate without user intervention, or interactive, meaning that all or part of the processes may include some user intervention.

Elements of different embodiments described herein may be combined to form other embodiments not specifically set forth above. Other embodiments not specifically described herein are also within the scope of the following claims.

What is claimed is:

1. A method comprising:
generating a process flow model comprised of tasks;
identifying a target task in the process flow model that fails or is not performed according to one or more predefined criteria;
identifying critical tasks which are necessary to perform the target task; and
suggesting training for critical tasks.

2. The method of claim 1, further comprising:
associating competencies with the tasks in the process flow model, the target task having one or more associated competencies;
wherein identifying critical tasks comprises:
comparing the one or more associated competencies with competencies of a worker who is to perform the target task;
identifying, based on the comparing, an associated competency that is not possessed by the worker; and
obtaining the critical tasks using the associated competency.

3. The method of claim 2, wherein obtaining the critical tasks comprises traversing a conceptual lattice that relates at least some of the tasks to at last some of the associated competencies.

4. The method of claim 1, wherein identifying the critical tasks comprises identifying one or more tasks that previously failed.

5. The method of claim 1, further comprising:
ordering the critical tasks based on priority, the training for critical tasks being suggested based on the priority, the priority corresponding to one or more costs associated with the critical tasks.

6. The method of claim 1, further comprising:
ordering the critical tasks based on time, the training for critical tasks being suggested based on a temporal order of the critical tasks.

7. The method of claim 1, further comprising:
ordering the critical tasks based on priority and time, the training for critical tasks being suggested based on the priority and on a temporal order of the critical tasks.

8. The method of claim 1, further comprising:
determining whether the process flow model is sound; and
if the process flow model is sound, suggesting training comprises suggesting training for a critical task that is earliest or has a highest priority.

9. The method of claim 1, further comprising:
determining whether the process flow model is sound; and
if the process flow model is sound, suggesting training comprises suggesting training for competencies associated with the critical task staring with a general competency.

10. The method of claim 1, further comprising:
determining whether the process flow model is sound; and
if the process flow model is not sound, identifying a subset of the process flow model that is sound and suggesting training for a critical task in a subset of the process flow model that is earliest or has a highest priority.

11. One or more machine-readable media for storing instructions that are executable by one or more processing devices to:
generate a process flow model comprised of tasks;
identify a target task in the process flow model that fails or is not performed according to one or more predefined criteria;
identify critical tasks which are necessary to perform the target task; and
suggest training for critical tasks.

12. The one or more machine-readable media of claim 11, further comprising instructions that are executable by one or more processing devices to:
associate competencies with the tasks in the process flow model, the target task having one or more associated competencies;
wherein identifying critical tasks comprises:
comparing the one or more associated competencies with competencies of a worker who is to perform the target task;
identifying, based on the comparing, an associated competency that is not possessed by the worker; and
obtaining the critical tasks using the associated competency.

13. The one or more machine-readable media of claim 12, wherein obtaining the critical tasks comprises traversing a conceptual lattice that relates at least some of the tasks to at last some of the associated competencies.

14. The one or more machine-readable media of claim 11, wherein identifying the critical tasks comprises identifying one or more tasks that previously failed.

15. The one or more machine-readable media of claim 11, further comprising instructions that are executable by one or more processing devices to:
order the critical tasks based on priority, the training for critical tasks being suggested based on the priority, the priority corresponding to one or more costs associated with the critical tasks.

16. The one or more machine-readable media of claim 11, further comprising instructions that are executable by one or more processing devices to:
order the critical tasks based on time, the training for critical tasks being suggested based on a temporal order of the critical tasks.

17. The one or more machine-readable media of claim 11, further comprising instructions that are executable by one or more processing devices to:
order the critical tasks based on priority and time, the training for critical tasks being suggested based on the priority and on a temporal order of the critical tasks.

18. The one or more machine-readable media of claim 11, further comprising instructions that are executable by one or more processing devices to:
determine whether the process flow model is sound; and
if the process flow model is sound, suggesting training comprises suggesting training for a critical task that is earliest or has a highest priority.

19. The one or more machine-readable media of claim 11, further comprising instructions that are executable by one or more processing devices to:
determine whether the process flow model is sound; and
if the process flow model is sound, suggesting training comprises suggesting training for competencies associated with the critical task staring with a general competency.

20. The one or more machine-readable media of claim 11, further comprising instructions that are executable by one or more processing devices to:
determine whether the process flow model is sound; and
if the process flow model is not sound, identify a subset of the process flow model that is sound and suggest training for a critical task in a subset of the process flow model that is earliest or has a highest priority.
